(19) United States
(12) Patent Application Publication
(10) Pub. No.: US 2017/0060640 A1
(43) Pub. Date: Mar. 2, 2017

(54) ROUTINE TASK ALLOCATING METHOD AND MULTICORE COMPUTER USING THE SAME

(71) Applicant: MStar Semiconductor, Inc., Hsinchu Hsien (TW)

(72) Inventors: Chih-Sheng Wang, Taipei City (TW); Yi-Shin Tung, Hsinchu County (TW)

(21) Appl. No.: 14/923,963

(22) Filed: Oct. 27, 2015

(30) Foreign Application Priority Data
Aug. 31, 2015 (TW) 104128622

(51) Int. Cl. G06F 9/50

(52) U.S. Cl. CPC G06F 9/5038

(57) ABSTRACT

A routine task allocating method of a multicore computer is provided. The multicore computer includes processor that includes a plurality of processing cores. The allocating method includes following steps. According to the number of the processing cores, a routine task is divided into a plurality of routine sub-tasks. The number of the routine sub-tasks is greater than or equal to the number of the processing cores. The routine sub-tasks are allocated according to an operation status of the multicore computer. Allocating the routine sub-tasks includes setting an execution sequence the routine sub-tasks as well as binding relationships between the routine sub-tasks and the processing cores.

This application claims the benefit of Taiwan application Serial No. 104128622, filed Aug. 31, 2015, the subject matter of which is incorporated herein by reference.

### BACKGROUND OF THE INVENTION

Field of the Invention

The invention relates in general to a task allocating method, and more particularly to a routine task allocating method and a multicore computer using the routine task allocating method.

Description of the Related Art

In operations of a multicore computer, there are numerous compute-intensive and routine tasks, e.g., memory cleanup tasks, data compression tasks, data downloading tasks, and hard drive restructuring tasks. These tasks may be referred to as routine tasks. Appropriately allocating routine tasks to accordingly prevent them from degrading execution efficiency of non-routine tasks is an essential research direction of the technical field.

### SUMMARY OF THE INVENTION

The invention is directed to a routine task allocating method and a multicore computer using the routine task allocating method. According to an operation status of the multicore computer, an execution sequence of a plurality of routine sub-tasks and binding relationships between the routine sub-tasks and a plurality of processing cores are dynamically allocated, thereby optimizing execution efficiency of routine tasks and non-routine tasks.

According to a first aspect of the present invention, a routine task allocating method is provided. The routine task allocating method is applied to a multicore computer including a processor. The processor includes a plurality of processing cores. The allocating method includes following steps. According to the number of the processing cores, a routine task is divided into a plurality of routine sub-tasks. The number of the routine sub-tasks is greater than or equal to the number of the processing cores. The routine sub-tasks are allocated according to an operation status of the multicore computer. Allocating the routine sub-tasks includes setting an execution sequence the routine sub-tasks as well as binding relationships between the routine sub-tasks and the processing cores.

According to a second aspect of the present invention, a multicore computer is provided. The multicore computer includes a processor and a memory. The processor includes a plurality of processing cores. The memory stores one or multiple sets of program codes to be executed by the processor to perform following steps. According to the number of the processing cores, a routine task is divided into a plurality of routine sub-tasks. The number of the routine sub-tasks is greater than or equal to the number of the processing cores. The routine sub-tasks are allocated according to an operation status of the multicore computer. Allocating the routine sub-tasks includes setting an execution sequence the routine sub-tasks as well as binding relationships between the routine sub-tasks and the processing cores.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a structural diagram of a multicore computer applying a routine task allocating method of the present invention;

FIG. 2 is a flowchart of a routine task allocating method according to an embodiment of the present invention;

FIG. 3 is a flowchart of a routine task allocating method according to another embodiment of the present invention;

FIG. 4 is a flowchart of a routine task allocating method according to another embodiment of the present invention;

FIG. 5 is a flowchart of a routine task allocating method according to another embodiment of the present invention;

FIG. 6 is a flowchart of a routine task allocating method according to another embodiment of the present invention; and

FIG. 7 is a schematic diagram of a non-routine task prioritized mode and a routine task prioritized mode.

### DETAILED DESCRIPTION OF THE INVENTION

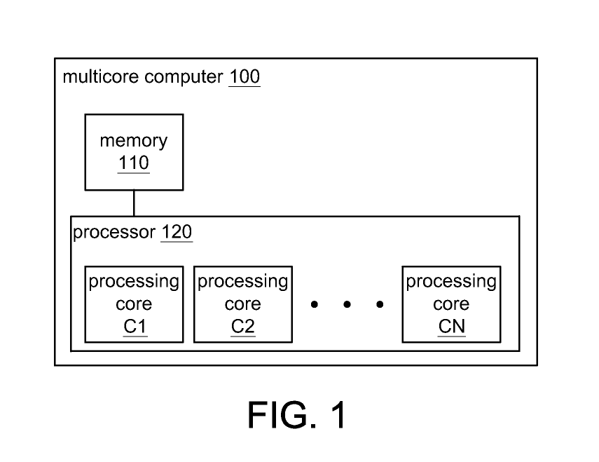

FIG. 1 shows a structural diagram of a multicore computer applying a routine task allocating method of the present invention. A multicore computer 100 includes a memory 110 and a processor 120. The processor 120 includes a plurality of processing cores C1, C2, . . . CN that execute various tasks, including routine tasks and non-routine tasks. For example, routine tasks are constantly executed memory cleanup tasks, data compression tasks, data downloading tasks, and hard drive restructuring tasks; non-routine tasks are text editing tasks, image display tasks, communication software messaging tasks, email transmitting tasks and remote controlled tasks. Compared to non-routine tasks, routine tasks have a lower urgency. Thus, in the presence of important non-tasks that need to be executed with priority, routine tasks may be suspended in order to execute these non-routine tasks. In the multicore computer 100, a routine task may be divided into a plurality of routine sub-tasks, which are respectively executed by the processing cores C1, C2 . . . CN in parallel to accelerate the speed for processing the routine task. In one embodiment, according to the number of the processing cores C1 to CN in the multicore computer 100, the processor 120 divides a routine task (not shown) into an N number of routine sub-tasks, including a 1^{st} routine sub-task (not shown), a 2^{nd} routine sub-task (not shown), . . . , and an N^{th} routine sub-task (not shown). The memory 110 stores program codes, and the processor 120 may execute the program codes stored in the memory 110 to implement the routine task allocating method of the present invention.

The multicore computer 100 has two task allocating modes—a non-routine task prioritized mode and a routine task prioritized mode. In the non-routine task prioritized mode, the processor 120 sets an execution sequence of the N routine sub-tasks from the 1^{st} routine sub-task to the N^{th} routine sub-task to a lowest priority, or referred to as an idle priority, and respectively binds the 1^{st} routine sub-task to the N^{th} routine sub-task to one of the processing cores C1 to CN. For example, the 1^{st} routine sub-task is bound to the processing core C1, the 2^{nd} routine sub-task is bound to the processing core C2, . . . , and the N^{th} routine sub-task is bound to the processing core CN. According to the execution sequence and the binding relationships of the 1^{st} routine sub-task to the N^{th} routine sub-task, the processor 120 allocates the 1^{st} routine sub-task to the N^{th} routine sub-task to a process pool of the processing cores C1 to CN. For example, the processor 120 allocates the 1^{st} routine sub-task having an execution sequence set to a lowest priority and bound to the processing core C1 to a position having an execution sequence with a lowest priority in the process pool of the processing core C1. Similarly, the processor 120 allocates the 2^{nd} routine sub-task having an execution sequence set to a lowest priority and bound to the processing core C2 to a position having an execution sequence with a lowest priority in the process pool of the processing core C2. That is, all of the 1^{st} routine sub-tasks to the N^{th} routine sub-tasks of the routine task are respectively allocated to the positions having an execution sequence with a lowest priority in the process pools of the processing cores C1 to CN. In general, the execution sequence of a non-routine task is not a least prioritized sequence, and thus the processing cores C1 to CN start processing routine sub-tasks having an execution sequence with a lowest priority only after having processed non-routine tasks having a higher priority in the process pools. In other words, in the non-routine task prioritized mode, non-routine tasks are prioritized and processed. Further, as each of the 1^{st} routine sub-task to the N^{th} routine sub-task is bounded to one of the processing cores C1 to CN, a migration issue of the 1^{st} routine sub-task to the N^{th} routine sub-task among the processing cores C1 to CN can be prevented.

It should be noted that, in the embodiment, the routine task is divided into an N number of routine sub-tasks including a 1^{st} routine sub-task to an N^{th} routine sub-task according to the N number of the processing cores C1 to CN in the multicore computer 100. In another embodiment, the routine task may be divided into an M number of routine sub-tasks including a 1^{st} routine sub-task to an M^{th} routine sub-task (not shown) according to the N number of the processing cores C1 to CN in the multicore computer 100, where M>N. The M number of 1^{st} routine sub-task to M^{th} routine sub-task are bound to the processing cores C1 to CN in an evenly distributed manner. Taking M=N+1 for example, the 1^{st} routine sub-task is bound to the processing core C1, the 2^{nd} routine sub-task is bound to the processing core C2, . . . , the N^{th} routine sub-task is bound to the processing core CN, and the M^{th} routine sub-task may be bound to one of the processing cores C1 to CN, e.g., to the processing core C1. That is, the 1^{st} routine sub-task and the M^{th} routine sub-task may be both bound to the processing core C1.

On the other hand, in the routine task prioritized mode, the processor 120 sets a part of routine sub-tasks to have an execution sequence with a lowest priority, and respectively binds that part of routine sub-tasks to one of the processing cores C1 to CN. The processor 120 further sets the remaining part of routine sub-tasks to have an execution sequence with a non-lowest priority, and does not bind that remaining part of routine sub-tasks to any of the processing cores C1 to CN. For example, the 2^{nd} routine sub-task is set to have an execution sequence with a lowest priority and is bound to the processing core C2, the 3^{rd} routine task is set to have an execution task with a lowest priority and is bound to the processing core C3, . . . , and the N^{th} routine task is set to have an execution task with a lowest priority and is bound to the processing core CN, whereas the 1^{st} routine sub-task is set to have a middle priority and is not bound to any processing core. According to the execution sequences and binding relationships of the 1^{st} routine sub-task to the N^{th} routine sub-task, the processor 120 allocates the 1^{st} routine sub-task to the N^{th} routine sub-task to the process pools of the processing cores C1 to CN. For example, the 2^{nd} routine sub-task set to have an execution task with a lowest priority and bound to the processing core C2 is allocated to a position having an execution sequence with a lowest priority in the process pool of the processing core C2, . . . , and the N^{th} routine sub-task set to have an execution task with a lowest priority and bound to the processing core CN is allocated to a position having an execution sequence with a lowest priority in the process pool of the processing core CN, whereas the 1^{st} routine sub-task set to have an execution sequence with a middle priority and not bound to any processing core is allocated to a position having an execution sequence with a middle priority in the process pool of one of the processing cores C1 to CN (e.g., the processing core C1). Thus, the 1^{st} routine sub-task can be executed without having to wait till all the non-routine tasks in the process pool of the processing core C1 are complete, thereby increasing the probability of executing the routine task and increasing an execution speed of the routine task. In other words, compared to the non-routine task prioritized mode, a routine task has a higher execution probability and a higher execution speed in the routine task prioritized mode.

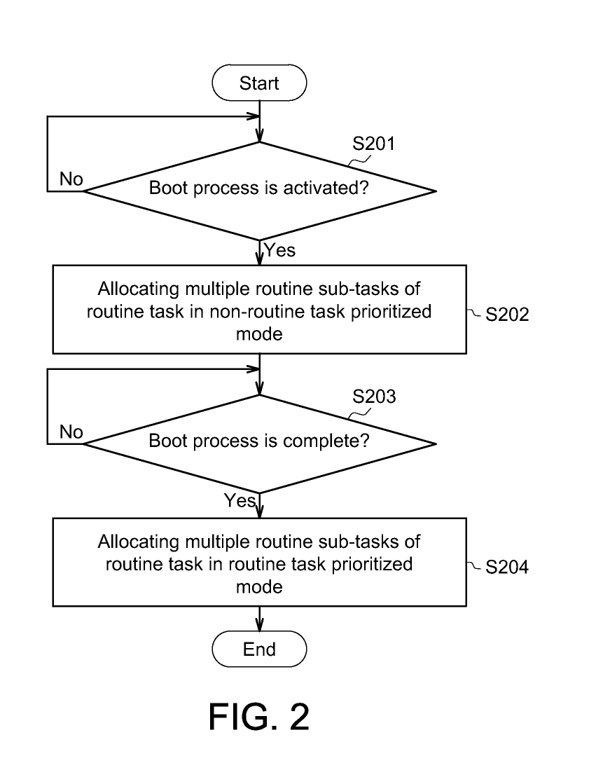

The non-routine task prioritized mode and the routine task prioritized mode have respective applicable situations. In general, when the execution speed of a non-routine task needs to be increased, the multicore computer 100 may allocate routine sub-tasks in the non-routine task prioritized mode; when the execution speed of a non-routine task does not need to be increased, the multicore computer 100 may allocate routine sub-tasks in the routine task prioritized mode. Various embodiments of dynamically allocating multiple routine sub-tasks of a routine task according to an operation status of the multicore computer 100 are given with the accompanying flowcharts below. A detection method may be an active and periodic detection, or an associated notification message may be passively obtained when the operation status changes. In one embodiment, the multicore computer 100 dynamically allocates multiple routine sub-tasks of a routine task according to a status of a boot process of the multicore computer 100. FIG. 2 shows a flowchart of a routine task allocating method according to an embodiment. In step S201, it is determined whether a boot process is activated. Step S202 is performed if so, or else step S201 is iterated. Whether the boot process is activated may be determined through a basic input/output system (BIOS). In step S202, multiple routine sub-tasks of a routine task are allocated in the non-routine task prioritized mode. For example, non-tasks that need to be executed with priority during the boot process include hardware information and built-in self-test (BIST) of the BIOS, obtaining the position of a device to be first booted according to the setting, reading and executing a boot loader of a master boot record (MBR) of the device to be first booted, and loading kernels according to the boot loader. Details of non-routine tasks can be referred from the foregoing description, and shall be omitted herein. In step S203, it is determined whether the boot process is complete. Step S204 is performed if so, or else step S203 is iterated. In step S204, multiple routine sub-tasks of a routine task are allocated in the routine task prioritized mode. Details of routine tasks can be referred from the foregoing description, and shall be omitted herein. As such, various non-routine tasks that need to be executed in the boot process can be executed with priority to accelerate the speed for booting, and the execution probability of routine tasks can be increased after the boot process is complete to accelerate the execution speed of routine tasks.

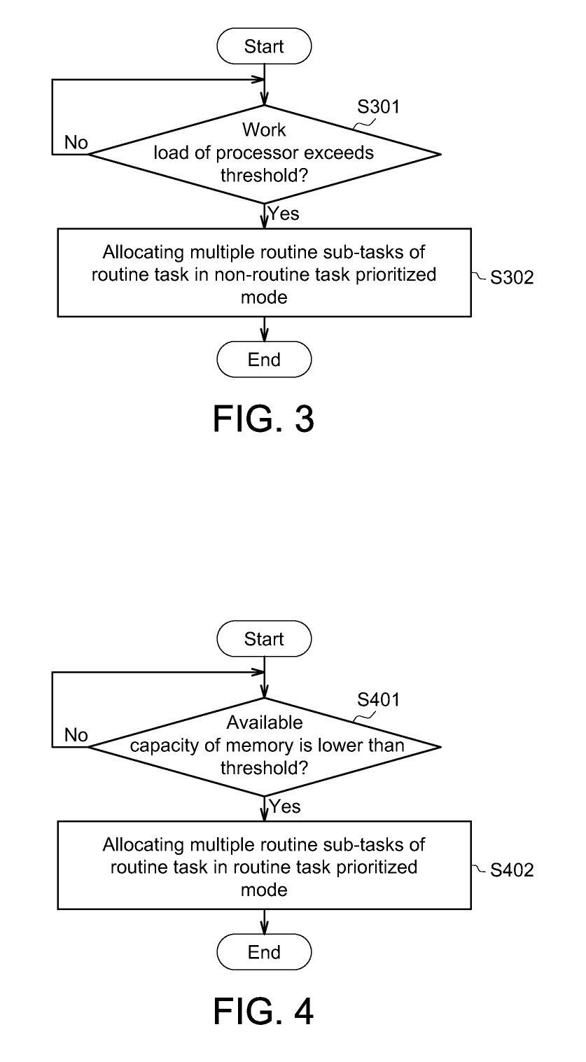

During an operation process of the multicore computer 120, changes may occur in hardware components such as the processor 120, the memory 110 and hard drives. For example, an overload may happen in the processor 120, excessively redundant data may exist in the memory 110 to cause a significantly reduced available capacity, and overly scattered data may occur in a hard drive to result in a lowered data access speed. Therefore, in another embodiment, the multicore computer 100 may dynamically allocate multiple routine sub-tasks of a routine task according to a status of a hardware component. FIG. 3 shows a routine task allocating method according to an embodiment. In step S301, it is determined whether an work load of the processor 120 exceeds a threshold. Step S302 is performed if so, or else step S301 is iterated. In step S302, multiple routine sub-tasks of a routine task are allocated in the non-routine task prioritized mode. Details of the non-routine task prioritized mode can be referred from the foregoing description, and shall be omitted herein. Thus, when the work load of the processor 120 gets large, the processor 120 may be prioritized to process non-routine tasks.

It should be noted that, the method for setting the execution sequence of the routine sub-tasks and the binding relationships between the routine sub-tasks and the processing cores C1 to CN according to the status of a hardware component is not limited the example shown in FIG. 3. In another embodiment, multiple routine sub-tasks of a routine task may be allocated in the routine task prioritized mode according to a detection result indicating that a work load is lower than a threshold.

FIG. 4 shows a flowchart of a routine task allocating method according to another embodiment. In the embodiment, the routine task is a cleanup task for the memory 110. In step S401, it is determined whether an available capacity of the memory 110 is lower than a threshold? Step S402 is performed if so, or else step S401 is iterated. In step S402, multiple routine sub-tasks of a routine task are allocated in the routine task prioritized mode. Details of the routine task prioritized mode can be referred from the foregoing description, and shall be omitted herein. Thus, when the memory 110 has a smaller available capacity, the execution probability of a memory 110 cleanup task can be increased to accelerate the execution speed of the memory 110 cleanup task.

It should be noted that, the method for setting the execution sequence of the routine sub-tasks and the binding relationships between the routine sub-tasks and the processing cores C1 to CN according to the available capacity of the memory 110 is not limited the example shown in FIG. 4. In another embodiment, multiple routine sub-tasks of a routine task may be allocated in the routine task prioritized mode according to a detection result indicating that an available capacity of the memory 110 is not lower than a threshold.

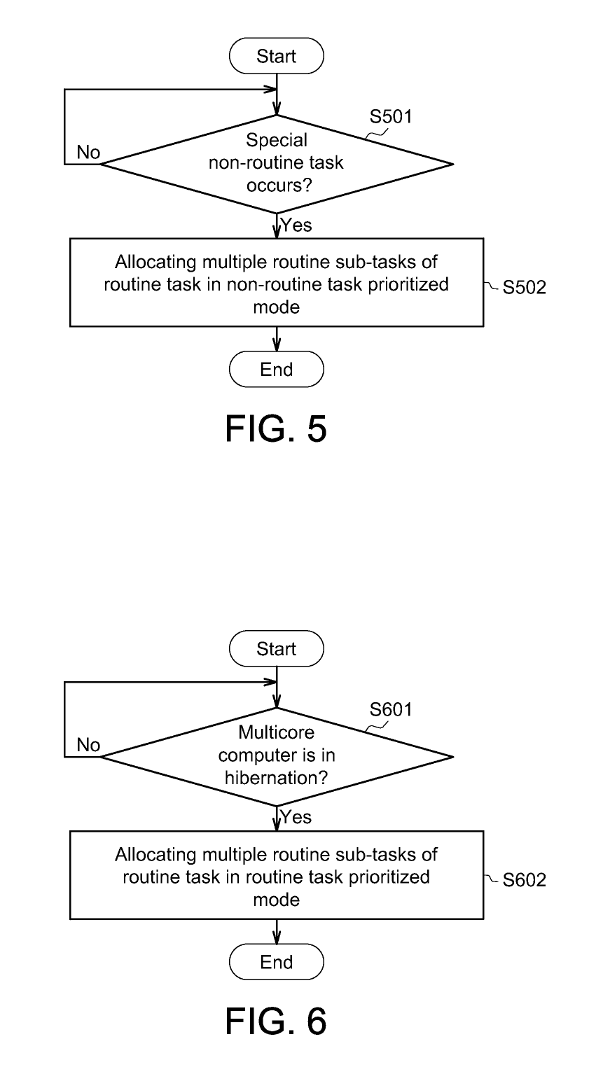

During an operation process of the multicore computer 110, special non-routine tasks that need to be executed with priority may occur. For example, when a user hits a keyboard, a special non-routine task of entering a character may occur. Therefore, in another embodiment, the multicore computer 100 may dynamically allocate multiple routine sub-tasks of a routine task according to whether a special non-routine task occurs. FIG. 5 shows a flowchart of a routine task allocating method according to another embodiment. In step S501, it is determined whether a special non-routine task occurs. Step S502 is performed if so, or else step S501 is iterated. In step S502, multiple routine sub-tasks of a routine task are allocated in the non-routine task prioritized mode. Details of the non-routine task prioritized mode and the routine task prioritized mode can be referred from the foregoing description, and shall be omitted herein. Thus, special non-routine tasks can be executed with priority to accelerate the speed of special non-routine tasks.

Further, the multicore computer 100 may enter hibernation, under which special non-routine tasks that need to be processed with priority are unlikely to occur. Therefore, in another embodiment, the multicore computer 100 may dynamically allocate multiple routine sub-tasks of a routine task according to whether the multicore computer 100 enters hibernation. FIG. 6 shows a flowchart of a routine task allocating method according to another embodiment. In step S601, it is determined whether the multicore computer 100 is in hibernation. Step S602 is performed if so, or else step S601 is iterated. In step S602, multiple routine sub-tasks of a routine task are allocated in the routine task prioritized mode. Details of the routine task prioritized mode can be referred from the foregoing description, and shall be omitted herein. Thus, while the multicore computer 100 is in hibernation, routine tasks can be executed with priority to accelerate the speed of routine tasks.

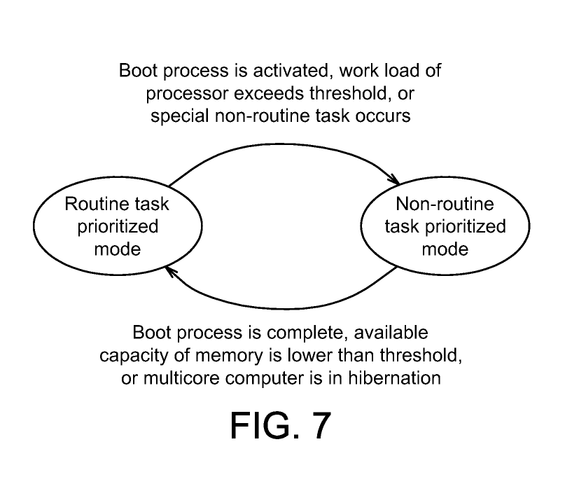

FIG. 7 shows a schematic diagram of a non-routine task prioritized mode and a routine task prioritized mode. When the boot process is activated, the work load of the processor 120 exceeds the threshold, or a special non-routine task occurs, multiple routine sub-tasks of a routine task are allocated in the non-routine task prioritized mode. When the boot process is complete, the available capacity of the memory 110 is lower than the threshold, or the multicore computer 100 is in hibernation, multiple routine sub-tasks of a routine task are allocated in the routine task prioritized mode. Thus, the multicore computer 100 is capable of dynamically allocating an execution sequence of routine sub-tasks of a routine task and binding relationships between these routine sub-tasks and the processing cores according to its operation status, thereby optimizing execution efficiency of routine tasks and non-routine tasks.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A routine task allocating method, applied to a multicore computer comprising a processor, the processor comprising a plurality of processing cores, the allocating method comprising:
dividing a routine task into a plurality of routine sub-tasks according to a number of the processing cores, a number of the routine sub-tasks being greater than or equal to the number of the processing cores; and
allocating the routine sub-tasks according to an operation status of the multicore computer, allocating the routine sub-tasks comprising setting an execution sequence of the routine sub-tasks and binding relationships between the routine sub-tasks and the processing cores.

2. The allocating method according to claim 1, wherein the step of allocating the routine sub-tasks according to the operation status of the multicore computer comprises:
allocating the routine sub-tasks selectively in a non-routine task prioritized mode or a routine task prioritized mode according to the operation status of the multicore computer;
wherein, when the routine sub-tasks are allocated in the non-routine task prioritized mode, all of the routine sub-tasks are set to have the execution sequence with a lowest priority and are respectively bound to one of the processing cores; and
when the routine sub-tasks are allocated in the routine task prioritized mode, a part of the routine sub-tasks are set to have the execution sequence with a non-lowest priority and are not bound to the processing cores.

3. The allocating method according to claim 2, wherein the step of allocating the routine sub-tasks selectively in the non-routine task prioritized mode or the routine task prioritized mode according to the operation status of the multicore computer comprises:
allocating the routine sub-tasks in the non-routine task prioritized mode according to a detection result indicating that the operation status of the multicore computer is that a boot process is activated.

4. The allocating method according to claim 2, wherein the step of allocating the routine sub-tasks selectively in the non-routine task prioritized mode or the routine task prioritized mode according to the operation status of the multicore computer comprises:
allocating the routine sub-tasks in the routine task prioritized mode according to a detection result indicating that the operation status of the multicore computer is that the boot process is completed.

5. The allocating method according to claim 2, wherein the step of allocating the routine sub-tasks selectively in the non-routine task prioritized mode or the routine task prioritized mode according to the operation status of the multicore computer comprises:
allocating the routine sub-tasks selectively in the non-routine task prioritized mode or the routine task prioritized mode according to a hardware component status of the multicore computer.

6. The allocating method according to claim 5, wherein the step of allocating the routine sub-tasks selectively in the non-routine task prioritized mode or the routine task prioritized mode according to the hardware component status of the multicore computer comprises:
allocating the routine sub-tasks in the non-routine task prioritized mode according to a detection result indicating that the hardware component status of the multicore computer is that a work load of the processor exceeds a threshold.

7. The allocating method according to claim 5, wherein the step of allocating the routine sub-tasks selectively in the non-routine task prioritized mode or the routine task prioritized mode according to the hardware component status of the multicore computer comprises:
allocating the routine sub-tasks in the routine task prioritized mode according to the hardware component status of the multicore computer that is a detection result indicating that an available capacity of a memory is lower than a threshold, wherein the routine task is a memory cleanup task.

8. The allocating method according to claim 2, wherein the step of allocating the routine sub-tasks according to the operation status of the multicore computer selectively in the non-routine task prioritized mode or the routine task prioritized mode comprises:
allocating the routine sub-tasks in the non-routine task prioritized mode according to a detection result indicating an occurrence of a special non-routine task.

9. The allocating method according to claim 2, wherein the step of allocating the routine sub-tasks according to the operation status of the multicore computer selectively in the non-routine task prioritized mode or the routine task prioritized mode comprises:
allocating the routine sub-tasks in the routine task prioritized mode according to a detection result indicating that the multicore computer is in hibernation.

10. A multicore computer, comprising:
a processor, comprising a plurality of processing cores; and
a memory, storing one or a plurality of sets of program codes to be executed by the processor to perform steps of:
dividing a routine task into a plurality of routine sub-tasks according to a number of the processing cores, a number of the routine sub-tasks being greater than or equal to the number of the processing cores; and
allocating the routine sub-tasks according to an operation status of the multicore computer, allocating the routine sub-tasks comprising setting an execution sequence of the routine sub-tasks and binding relationships between the routine sub-tasks and the processing cores.

11. The multicore computer according to claim 10, wherein the step of allocating the routine sub-tasks according to the operation status of the multicore computer comprises:
allocating the routine sub-tasks selectively in a non-routine task prioritized mode or a routine task prioritized mode according to the operation status of the multicore computer;
wherein, when the routine sub-tasks are allocated in the non-routine task prioritized mode, all of the routine sub-tasks are set to have the execution sequence with a lowest priority and are respectively bound to one of the processing cores; and
when the routine sub-tasks are allocated in the routine task prioritized mode, a part of the routine sub-tasks are set to have the execution sequence with a non-lowest priority and are not bound to the processing cores.

12. The multicore computer according to claim 11, wherein the step of allocating the routine sub-tasks selectively in the non-routine task prioritized mode or the routine task prioritized mode according to the operation status of the multicore computer comprises:
allocating the routine sub-tasks in the non-routine task prioritized mode according to a detection result indicating that the operation status of the multicore computer that is a boot process is activated.

13. The multicore computer according to claim 11, wherein the step of allocating the routine sub-tasks selectively in the non-routine task prioritized mode or the routine task prioritized mode according to the operation status of the multicore computer comprises:
allocating the routine sub-tasks in the routine task prioritized mode according to a detection result indicating that the operation status of the multicore computer that is the boot process is complete.

14. The multicore computer according to claim 11, wherein the step of allocating the routine sub-tasks selectively in the non-routine task prioritized mode or the routine task prioritized mode according to the operation status of the multicore computer comprises:
allocating the routine sub-tasks selectively in the non-routine task prioritized mode or the routine task prioritized mode according to a hardware component status of the multicore computer.

15. The multicore computer according to claim 14, wherein the step of allocating the routine sub-tasks selectively in the non-routine task prioritized mode or the routine task prioritized mode according to the hardware component status of the multicore computer comprises:
allocating the routine sub-tasks in the non-routine task prioritized mode according to a detection result indicating that the hardware component status of the multicore computer that is a work load of the processor exceeds a threshold.

16. The multicore computer according to claim 14, wherein the step of allocating the routine sub-tasks selectively in the non-routine task prioritized mode or the routine task prioritized mode according to the hardware component status of the multicore computer comprises:
allocating the routine sub-tasks in the routine task prioritized mode according to the hardware component status of the multicore computer that is a detection result indicating that an available capacity of a memory is lower than a threshold, wherein the routine task is a memory cleanup task.

17. The multicore computer according to claim 11, wherein the step of allocating the routine sub-tasks according to the operation status of the multicore computer selectively in the non-routine task prioritized mode or the routine task prioritized mode comprises:
allocating the routine sub-tasks in the non-routine task prioritized mode according to a detection result indicating an occurrence of a special non-routine task.

18. The multicore computer according to claim 11, wherein the step of allocating the routine sub-tasks according to the operation status of the multicore computer selectively in the non-routine task prioritized mode or the routine task prioritized mode comprises:
allocating the routine sub-tasks in the routine task prioritized mode according to a detection result indicating that the multicore computer is in hibernation.
